(19) United States
(12) Patent Application Publication
(10) Pub. No.: US 2002/0070265 A1
(43) Pub. Date: Jun. 13, 2002

(54) Postcard with included multimedia software

(76) Inventors: Kevin R. Utter, Seatle, WA (US); Matthew A. Kramer, Seattle, WA (US)

Correspondence Address: Kevin R. Utter, 3026 11th Ave. West, Seattle, WA, 98119, US

(21) Appl. No.: 09/734,346

(22) Filed: Dec. 11, 2000

(51) Int. Cl. B42D 15/00

(52) U.S. Cl. 229/92.8

(57) ABSTRACT

A package containing a picture postcard and a multimedia software presentation on digital media. The postcard has a picture or illustration relevant to the geographic location it is being sold. The attached multimedia software presentation also contains images, video and information that are relevant to the general location in which the postcard is sold.

### FIELD OF THE INVENTION

This invention relates to packaging for consumer products.

### BACKGROUND OF INVENTION

Picture postcards with a picture or drawing on one side, and an address space and area for a message on the reverse side became popular around 1907 and are today well known. A great deal of competition exists in the postcard industry and manufacturers have expanded their product offering to include expandable, or accordion postcard products, pocket calendars, local guide packets and other tourist novelty products.

In general, postcards can be grouped into three main areas. The first area is Local View Cards, cards with a specific view of a specific local area. An example would be a picture postcard of the Jefferson Memorial sold in the Washington D.C. area. The second group is Regional/General View Cards, cards with more general images sold in a wider geographic area. An example of the group would be a picture postcard with a beach scene sold in many cities along a large costal area. The third group includes postcards promoting an Activity or Business. Examples of this group might include a postcard produced by a Boat Cruise Line for sale in its gift shops, or a postcard sent by a business to promote its products or services.

Because of such stiff competition in the postcard industry, a need exists for manufacturers to differentiate their products and catch the attention of shoppers and potential customers.

With the wide spread use and acceptance of personal computers, multimedia software had become a major business. The distribution of multimedia such as pictures, sound and video distributed via computer diskette, CD-ROM, computer-DVD and the Internet (WEB) is now commonplace. A multimedia software package containing views and information from local sites, or more general views and information for a larger audience can easily be produced with current technology.

Combining a postcard targeted to the tourist market, with a relevant multimedia software presentation in a small physical format, CD-ROM or DVD, addresses the need for a postcard manufacturer to differentiate themselves in the marketplace.

### SUMMARY OF INVENTION

It is an object of this invention to provide a package containing both a souvenir postcard and multimedia software media.

In accordance with one aspect of the present invention, there is provided a picture postcard with a graphic or picture on one side. The opposite side of the dual sided postcard contains areas for postal address, a message to the recipient, a postal stamp and attached multimedia software or presentation in digital format. The preferred form of the multimedia software is a standard personal computer CD-ROM or DVD disk in a protective sleeve. The preferred postcard is made from standard postcard quality paper stock that is the current standard for the industry.

In accordance with another aspect of the present invention, the package consists of a once folded picture postcard that contains a picture or graphic on one outside surface. The opposite outside surface contains areas for postal address, a message to the recipient and postal stamp. Opening the postcard reveals additional pictures or graphics and additional text. A multimedia CD-ROM or DVD is attached inside the postcard, and is generally in a protective sleeve.

It will be understood by those having skill in the art that other postcard materials, features and advantages will become apparent from the following detailed description. It is to be understood that the detailed description and specific examples, while preferred package configurations, are given by way of illustration and not limitation. Many changes and modifications within the scope of the present invention may be made without departing from the sprit thereof, and the invention includes all such modifications.

### BRIEF DESCRIPTION OF DRAWINGS

FIG. 1 is a rear view of a picture postcard package with attached multimedia software which is a mini CD-ROM in accordance with the teachings of this invention.

FIG. 2 is a rear view of the picture postcard of FIG. 1 with multimedia software removed from the package of FIG. 1.

FIG. 3 is a front view of the picture postcard of FIG. 1.

FIG. 4 is a front view of a picture postcard package containing attached multimedia software which is a standard CD-ROM in accordance with the teachings of this invention.

FIG. 5 is a rear view of a picture postcard of FIG. 4 with attached standard size CD-ROM.

FIG. 6 is a rear view of a picture postcard of FIG. 4 with multimedia software removed from the package of FIG. 4.

FIG. 7 is a front view of a picture postcard package with included multimedia software which is a DVD in accordance with the teachings of this invention.

FIG. 8 is a rear view of a picture postcard package with included multi media software of FIG. 7.

FIG. 9 is an inside view of the picture postcard package of FIG. 7 containing multimedia software on DVD media and additional text and pictures in accordance with another aspect of this invention.

### DETAILED DESCRIPTION

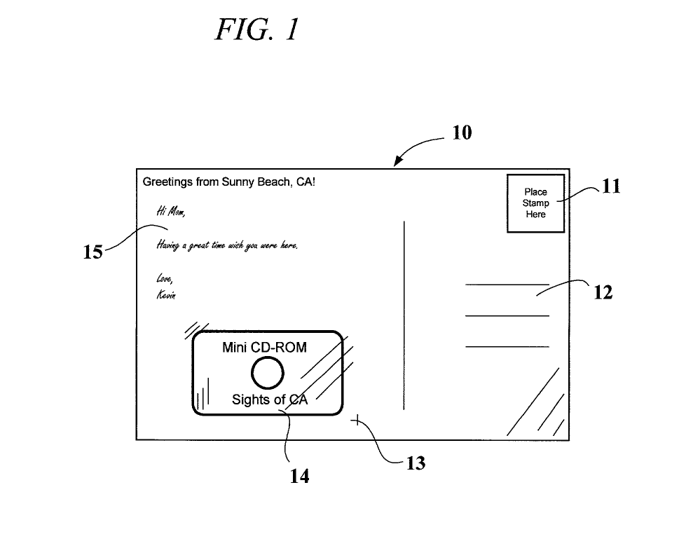

Referring now to FIG. 1 of the drawing, a single package is shown having a picture postcard 10 and attached multimedia software miniature CD-ROM 14. The picture postcard shown is of a standard type in the industry of the approximate size of 6 inches wide and 4 inches tall with an area for address 12, a greeting 15 and area for a postal stamp 11. In addition to this standard picture postcard a protective sleeve 13 has been attached that contains multimedia software, in this view a miniature CD-ROM 14 of standard type in the industry for use on personal computers with standard CD-ROM drives. The protective sleeve 13 can be of most any material but the preferred package consists of clear plastic or a paper sleeve with a clear cellophane window for viewing.

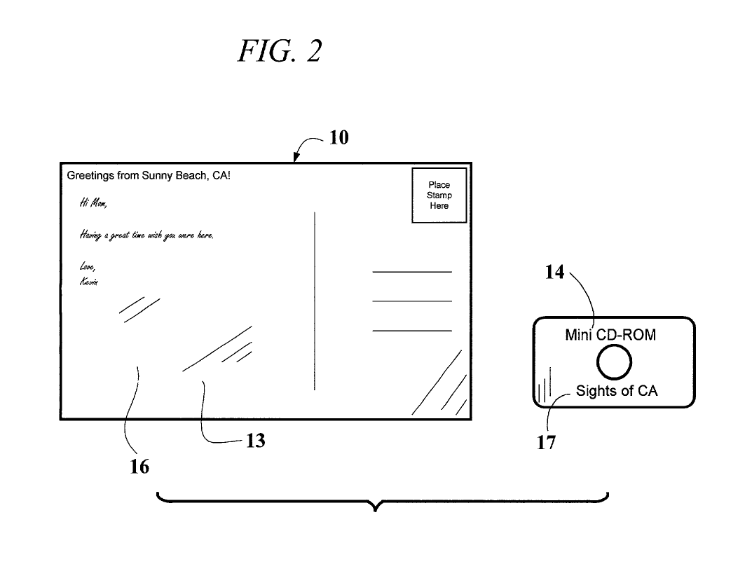

As seen in FIG. 2, the mini CD-ROM 14 can be removed from the picture postcard 10 and the protective sleeve 13 remains attached to the picture postcard 16. The multimedia CD-ROM 14 can then be inserted in an industry standard CD-ROM drive to be viewed.

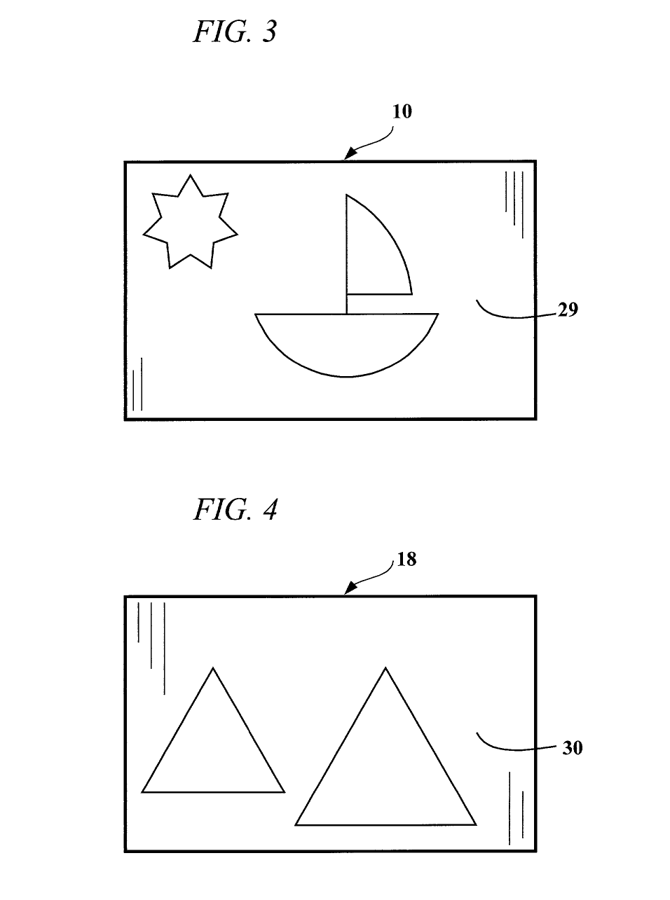

As seen in FIG. 3, the picture postcard 10 has indicia 29 having some relevance to the area in which it is being sold, as is the standard in the industry. The CD-ROM of FIG. 2 14 also has an indicia FIG. 2 17 that is relevant to the area the package is being sold.

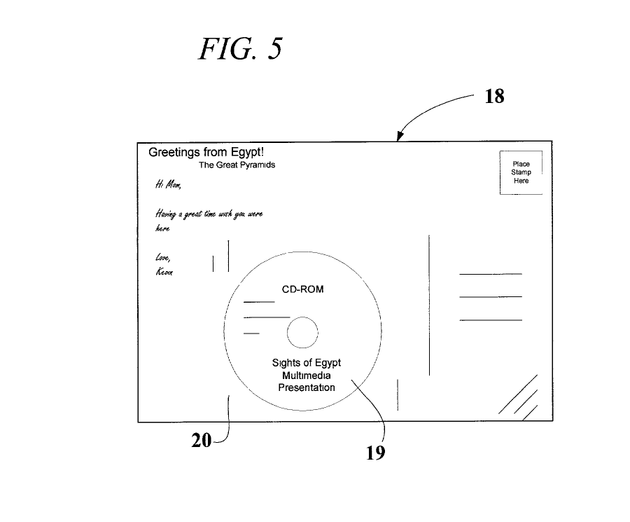

FIG. 4 is a picture postcard 18 of a size that is determined by the size of the software media attached to it FIG. 5 19. The indicia of the postcard FIG. 4 30 has relevance to the location that it is being sold.

The standard size CD-ROM of FIG. 5 19 is attached to the postcard with a protective sleeve 20 and has an indicia that is relevant to the picture postcard it is attached 18. The protective sleeve 20 can be of most any material but the preferred package consists of clear plastic or a paper sleeve with a clear cellophane window for viewing. The multimedia software contained on the standard size CD-ROM 19 is also relevant to the location that the package is being sold.

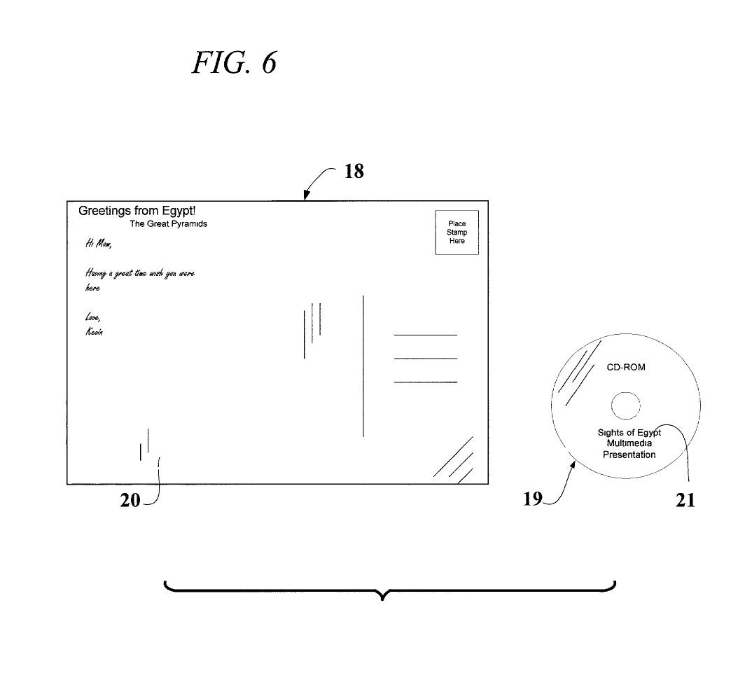

FIG. 6 shows the CD-ROM 19 can be removed from the postcard 18 and the protective sleeve 20 remains attached to the picture postcard 18. The multimedia CD-ROM 19 can then be inserted in an industry standard CD-ROM drive to be viewed. The indicia 21 may contain additional text such as instructions for installing the multimedia software.

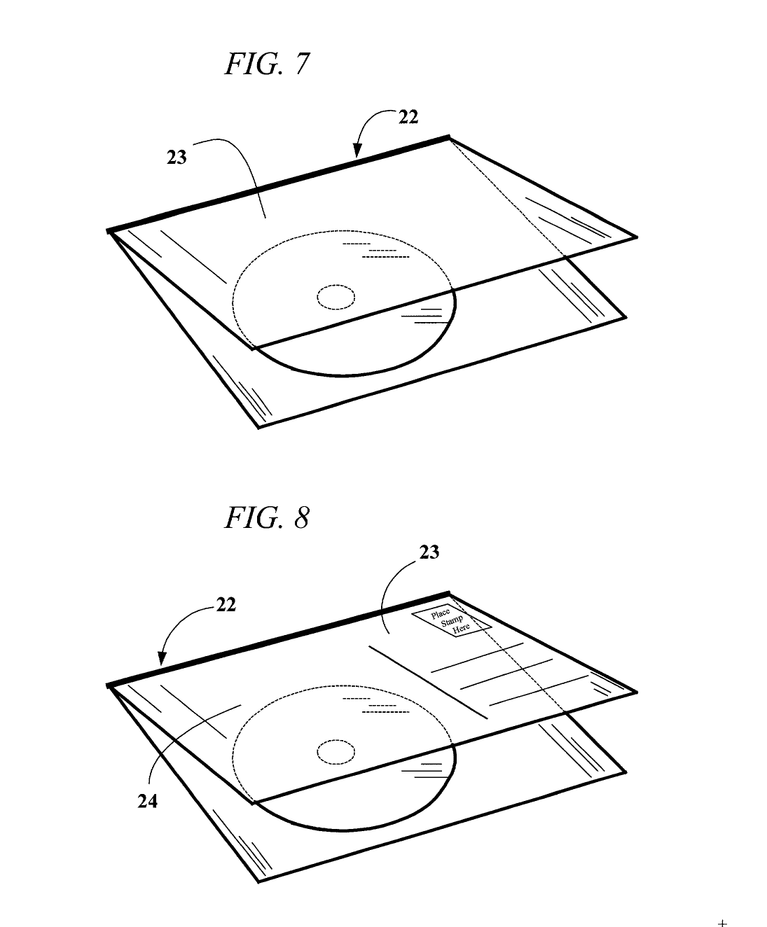

FIG. 7 is a front view of a picture postcard 23 that is in the form of a folding card with a fold indicated as in 22. It is sized so as to be able to accept the size of multimedia software media contained within the package.

FIG. 8 is the back view 23 of the postcard indicated in FIG. 7 23. The back of postcard 23 has all the requirements of postcard able to be sent in the postal system requiring address, stamp and contains a space for a brief greeting 24.

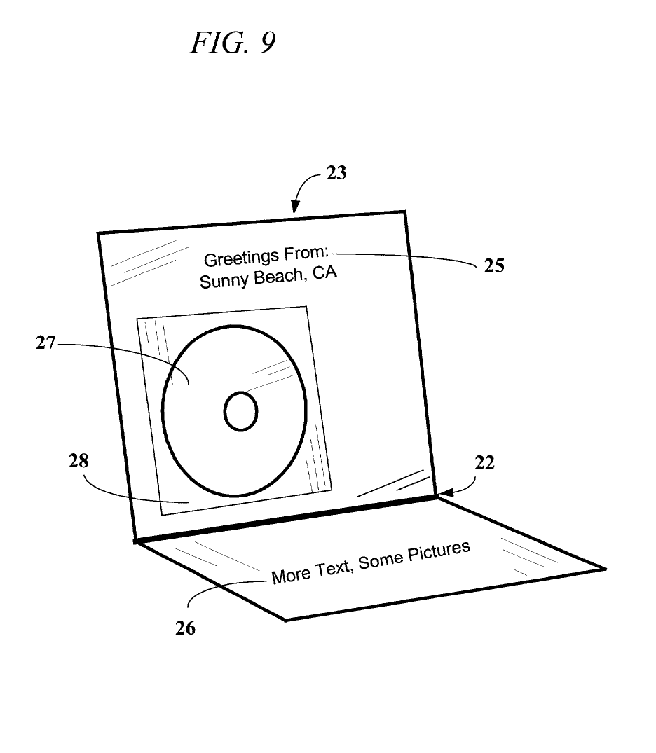

FIG. 9 is the inside, or unfolded view of postcard 23. As indicated in FIG. 9 the inside contains a space for additional indicia 25 and 26, multimedia software media 27 and a protective sleeve holder 28 for the media. All postcard indicia, media indicia and multimedia software are relevant to the location where the postcard 23 is being sold.

We claim:

1. A picture postcard and attached digital media both having relevance to the location that they are sold.

2. A consumer package targeted to the tourist marketplace comprising:
(a) a postcard with a picture or artwork relevant to the location it is being sold;
(b) a multimedia software presentation on digital media relevant to the location being sold.

3. A consumer package to be purchased by a consumer as a single unit, said package comprising:
(a) a postcard with a picture or artwork relevant to the area being sold with an opposite side having standard postcard attributes of address space, message space and postal stamp space;
(b) a multimedia software presentation on digital media that contains pictures, sound and standard software as to allow the viewing of the said multimedia presentation on a standard computer or DVD player.
